(19) United States
(12) Patent Application Publication
(10) Pub. No.: US 2019/0026627 A1
(43) Pub. Date: Jan. 24, 2019

(54) VARIABLE PRECISION NEUROMORPHIC ARCHITECTURE

(71) Applicant: Samsung Electronics Co., Ltd., Suwon-si (KR)

(72) Inventors: Ryan M. Hatcher, Austin, TX (US); Jorge A. Kittl, Austin, TX (US); Borna J. Obradovic, Leander, TX (US); Titash Rakshit, Austin, TX (US)

(21) Appl. No.: 15/891,220

(22) Filed: Feb. 7, 2018

Related U.S. Application Data
(60) Provisional application No. 62/535,187, filed on Jul. 20, 2017.

(51) Int. Cl. G06N 3/063; G06N 3/04

(52) U.S. Cl. CPC G06N 3/0635; G06N 3/04

(57) ABSTRACT

A neuromorphic architecture for providing variable precision in a neural network, through programming. Logical pre-synaptic neurons are formed as configurable sets of physical pre-synaptic artificial neurons, logical post-synaptic neurons are formed as configurable sets of physical post-synaptic artificial neurons, and the logical pre-synaptic neurons are connected to the logical post-synaptic neurons by logical synapses each including a set of physical artificial synapses. The precision of the weights of the logical synapses may be varied by varying the number of physical pre-synaptic artificial neurons in each of the logical pre-synaptic neurons, and/or by varying the number of physical post-synaptic artificial neurons in each of the logical post-synaptic neurons.

### CROSS-REFERENCE TO RELATED APPLICATION(S)

The present application claims priority to and the benefit of U.S. Provisional Application No. 62/535,187, filed Jul. 20, 2017, entitled “VARIABLE PRECISION NEUROMORPHIC ARCHITECTURE”, the entire content of which is incorporated herein by reference.

### FIELD

One or more aspects of embodiments according to the present invention relate to artificial neural networks, and more particularly to a variable precision neuromorphic architecture.

### BACKGROUND

Artificial neural networks (or, as used herein, simply “neural networks”) may perform machine learning and decision-making using data processing that may be computationally costly, e.g., including significant numbers of multiply accumulate (MAC) operations. This computational cost may result in slow processing, or in high power consumption and equipment cost if speed is to be improved.

Thus, there is a need for an improved artificial neural network.

### SUMMARY

Aspects of embodiments of the present disclosure are directed toward a neuromorphic architecture for providing variable precision in a neural network, through programming. Logical pre-synaptic neurons are formed as configurable sets of physical pre-synaptic artificial neurons, logical post-synaptic neurons are formed as configurable sets of physical post-synaptic artificial neurons, and the logical pre-synaptic neurons are connected to the logical post-synaptic neurons by logical synapses each including a set of physical artificial synapses. The precision of the weights of the logical synapses may be varied by varying the number of physical pre-synaptic artificial neurons in each of the logical pre-synaptic neurons, and/or by varying the number of physical post-synaptic artificial neurons in each of the logical post-synaptic neurons.

According to an embodiment of the present invention there is provided a neural network, including: a plurality of pre-synaptic artificial neurons; a plurality of post-synaptic artificial neurons; and a plurality of artificial synapses, each of the artificial synapses being connected between a respective pre-synaptic artificial neuron of the pre-synaptic artificial neurons and a respective post-synaptic artificial neuron of the post-synaptic artificial neurons, each of the artificial synapses having a respective weight, each of the pre-synaptic artificial neurons including a respective multiplying circuit programmable to amplify its output signal by a gain factor selected from a set of N gain values being, respectively, A, 2A, 4A, . . . 2^{N-1}A, wherein N is an integer greater than 1 and A is a constant, each of the pre-synaptic artificial neurons being programmed to amplify its output signal by a gain factor that is different from that of the other pre-synaptic artificial neurons, each of the post-synaptic artificial neurons including a respective multiplying circuit programmable to amplify its input signal, and each of the post-synaptic artificial neurons being programmed to amplify its output signal by a gain factor that is different from that of the other post-synaptic artificial neurons.

In one embodiment, each of the pre-synaptic artificial neurons is configured to produce, as an output signal, a voltage.

In one embodiment, each of the weights is a conductance of a resistive element.

In one embodiment, each resistive element is configured to operate in one of: a first state, in which the resistive element has a first conductance; and a second state, in which the resistive element has a second conductance different from the first conductance.

In one embodiment, each resistive element is a programmable resistive element within a spin-transfer torque random access memory cell.

In one embodiment, all of the weights have the same first conductance and all of the weights have the same second conductance.

In one embodiment, each of the post-synaptic artificial neurons is configured to receive, as an input signal, a current.

In one embodiment, each of the post-synaptic artificial neurons has a respective multiplying circuit programmable to amplify its output signal by a gain factor selected from a set of M gain values being, respectively, B, 2^{N}B, 4^{2N}B, . . . 2^{(M-1)}B, wherein M is an integer greater than 1 and A is a constant.

According to an embodiment of the present invention there is provided a neural network including: a plurality of logical pre-synaptic neurons; a plurality of logical post-synaptic neurons; and a plurality of logical synapses, a first logical pre-synaptic neuron of the logical pre-synaptic neurons having an input and including N pre-synaptic artificial neurons, N being an integer greater than 1, each of the N pre-synaptic artificial neurons having a respective input, all of the inputs of the pre-synaptic artificial neurons being connected to the input of the first logical pre-synaptic neuron, a first logical post-synaptic neuron of the logical post-synaptic neurons having an output and including: M post-synaptic artificial neurons, M being an integer greater than 1; and a summing circuit having: an output connected to the output of the first logical post-synaptic neuron, and a plurality of inputs, each of the M post-synaptic artificial neurons having a respective output, the output of each of the post-synaptic artificial neurons being connected to a respective input of the plurality of inputs of the summing circuit.

In one embodiment, each of the N pre-synaptic artificial neurons includes a respective multiplying circuit programmable to amplify its output signal by a gain factor selected from a set of N gain values being, respectively, A, 2A, 4A, . . . 2^{N}A, wherein A is a constant.

In one embodiment, each of the M post-synaptic artificial neurons includes a respective multiplying circuit programmable to amplify its output signal by a gain factor selected from a set of M gain values being, respectively, B, 2^{N}B, 4^{2N}B, . . . 2^{(M-1)N}B, wherein A is a constant.

In one embodiment, all of the pre-synaptic artificial neurons differ only with respect to their respective programmed gain factors.

In one embodiment, all of the post-synaptic artificial neurons differ only with respect to their respective programmed gain factors.

In one embodiment, an input of each pre-synaptic artificial neuron is a digital input; the multiplying circuit of each pre-synaptic artificial neuron is a digital multiplying circuit connected to the input of the pre-synaptic artificial neuron; and each pre-synaptic artificial neuron further includes a digital to analog converter having an input connected to an output of the digital multiplying circuit and an output connected to an output of the pre-synaptic artificial neuron.

In one embodiment, an output of each post-synaptic artificial neuron is a digital output; the multiplying circuit of each post-synaptic artificial neuron is a digital multiplying circuit connected to the output of the post-synaptic artificial neuron; and each post-synaptic artificial neuron further includes an analog to digital converter having an input connected to an input of the post-synaptic artificial neuron and an output connected to an input of the digital multiplying circuit.

In one embodiment, the first logical post-synaptic neuron further includes a digital summing circuit having M inputs each connected to a respective one of the outputs of the M post-synaptic artificial neurons and an output connected to the output of the first logical post-synaptic neuron.

In one embodiment, each of the pre-synaptic artificial neurons is configured to produce, as an output signal, a voltage; each of the logical synapses includes a plurality of artificial synapses, each of the artificial synapses having a respective weight, each weights being a conductance of a resistive element; and each of the post-synaptic artificial neurons is configured to receive, as an input signal, a current.

In one embodiment, each resistive element is configured to operate in one of: a first state, in which the resistive element has a first conductance; and a second state, in which the resistive element has a second conductance different from the first conductance.

In one embodiment, each resistive element is a programmable resistive element within spin-transfer torque random access memory cell.

According to an embodiment of the present invention there is provided a neural network, including: a plurality of pre-synaptic artificial neurons; a plurality of post-synaptic artificial neurons; and means for forming a plurality of connections, each connection being between a respective pre-synaptic artificial neuron of the pre-synaptic artificial neurons and a respective post-synaptic artificial neuron of the post-synaptic artificial neurons, each of the pre-synaptic artificial neurons including a respective multiplying circuit programmable to amplify its output signal by a gain factor selected from a set of N gain values being, respectively, A, 2A, 4A, . . . 2^{N-1}A, wherein N is an integer greater than 1 and A is a constant, each of the pre-synaptic artificial neurons being programmed to amplify its output signal by a gain factor that is different from that of the other pre-synaptic artificial neurons, each of the post-synaptic artificial neurons including a respective multiplying circuit programmable to amplify its input signal, and each of the post-synaptic artificial neurons being programmed to amplify its output signal by a gain factor that is different from that of the other post-synaptic artificial neurons.

### BRIEF DESCRIPTION OF THE DRAWINGS

These and other features and advantages of the present invention will be appreciated and understood with reference to the specification, claims, and appended drawings wherein:

FIG. 1 is a block diagram of a portion of a neural network, according to an embodiment of the present invention;

FIG. 2A is an equation related to a neural network, according to an embodiment of the present invention;

FIG. 2B is an equation related to a neural network, according to an embodiment of the present invention;

FIG. 2C is an equation related to a neural network, according to an embodiment of the present invention;

FIG. 3A is a block diagram of a portion of a neural network, according to an embodiment of the present invention;

FIG. 3B is a block diagram of a portion of a neural network, according to an embodiment of the present invention;

FIG. 3C is a diagram of several configurations for a synapse, according to an embodiment of the present invention;

FIG. 4 is a block diagram of a portion of a neural network, according to an embodiment of the present invention;

FIG. 5 is a block diagram of a portion of a neural network, according to an embodiment of the present invention;

FIG. 6 is a block diagram of a portion of a neural network, according to an embodiment of the present invention;

FIG. 7A is a block diagram of an artificial neuron, according to an embodiment of the present invention;

FIG. 7B is a block diagram of an artificial neuron, according to an embodiment of the present invention; and

FIG. 7C is a block diagram of logical neuron, according to an embodiment of the present invention.

### DETAILED DESCRIPTION

The detailed description set forth below in connection with the appended drawings is intended as a description of exemplary embodiments of a variable precision neuromorphic architecture provided in accordance with the present invention and is not intended to represent the only forms in which the present invention may be constructed or utilized. The description sets forth the features of the present invention in connection with the illustrated embodiments. It is to be understood, however, that the same or equivalent functions and structures may be accomplished by different embodiments that are also intended to be encompassed within the spirit and scope of the invention. As denoted elsewhere herein, like element numbers are intended to indicate like elements or features.

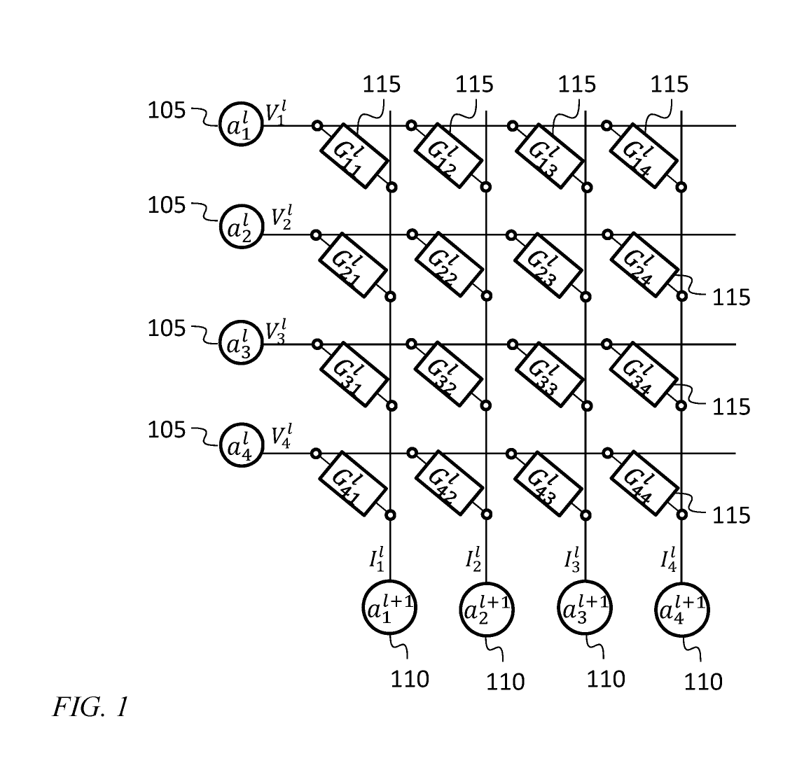

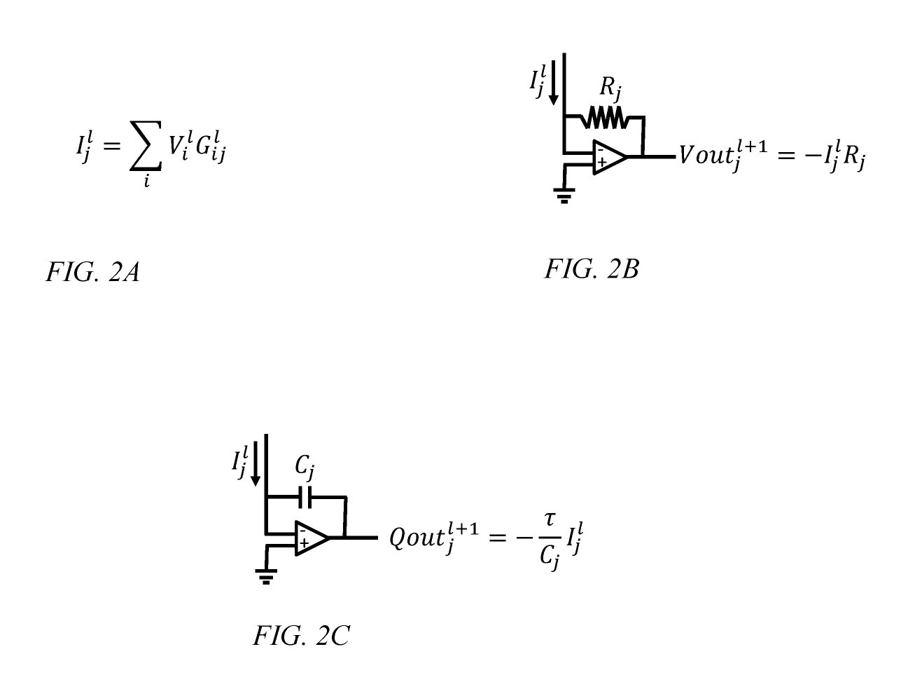

Referring to FIG. 1, in one embodiment a neural network includes a plurality of pre-synaptic artificial neurons 105 connected to a plurality of post-synaptic artificial neurons 110 though a plurality of artificial synapses 115. As used herein, an “artificial neuron” is an element with an input and an output, and which may be configured to generate, at the output, a signal that is a nonlinear function (which may be referred to as an “activation function” or “transfer function”) of the input. Each of the pre-synaptic artificial neurons 105 may generate, as output, a voltage, and each of the post-synaptic artificial neurons 110 may receive, as input, a current, which may be a weighted sum of the outputs of the pre-synaptic artificial neurons 105 to which it is connected by artificial synapses 115. Each artificial synapse 115 is a connection between the output of a pre-synaptic artificial neuron 105 and the input of a post-synaptic artificial neuron 110. Each artificial synapse 115 may be a resistor or other resistive element. In such an embodiment, the weights Gᵢⱼ^{l} of the weighted sum may be the conductance (i.e., the reciprocal of the resistance) of each artificial synapse 115, so that, for example, the total current received by a post-synaptic artificial neurons 110 may be (shown in the equation of FIG. 2A) the sum over all of the pre-synaptic artificial neurons 105 to which it is connected, of the product, for each such of pre-synaptic artificial neuron 105 of (i) the output (voltage) of the pre-synaptic artificial neuron 105 and (ii) the weight (i.e., the conductance) of the artificial synapse 115.

FIG. 1 illustrates one layer (the l-th layer) [Ryan: is this correct, or is it customary to refer to the layer shown as the (l+1)-th layer?] of a neural network that may include a plurality of layers connected in cascade. For example each of the post-synaptic artificial neurons 110 shown in FIG. 1 may have an output connected, through additional artificial synapses 115 to other artificial neurons, and, as such, may act as a pre-synaptic artificial neurons 105 in a subsequent layer. As such, each of the weights Gᵢⱼ^{l} may be identified by a superscript (l) identifying the layer, and first and second subscripts (i and j) identifying the pre-synaptic artificial neuron 105 and the post-synaptic artificial neurons 110 to which the artificial synapse 115 (to which the weight corresponds) is connected.

Each of the post-synaptic artificial neurons 110 may have at its input a circuit such as the transimpedance amplifier of FIG. 2B, or the integrator of FIG. 2C. The latter may be used in an embodiment in which the signals are pulse-width modulated (e.g., a longer duration voltage pulse, resulting in a longer duration current pulse is used to signal a larger value, and a shorter duration voltage pulse resulting in a shorter duration current pulse is used to signal a smaller value).

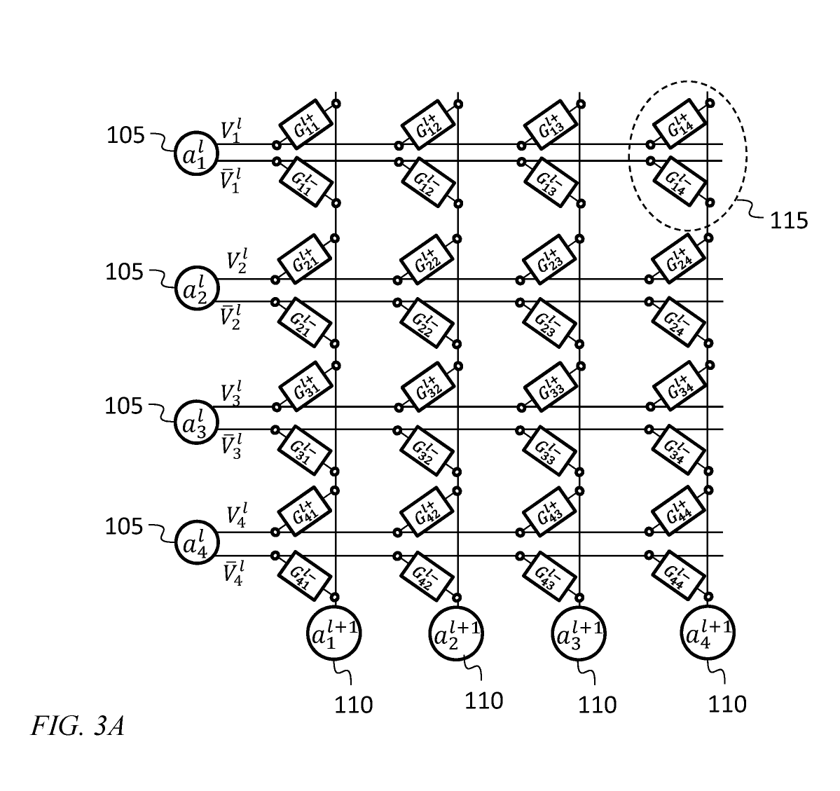

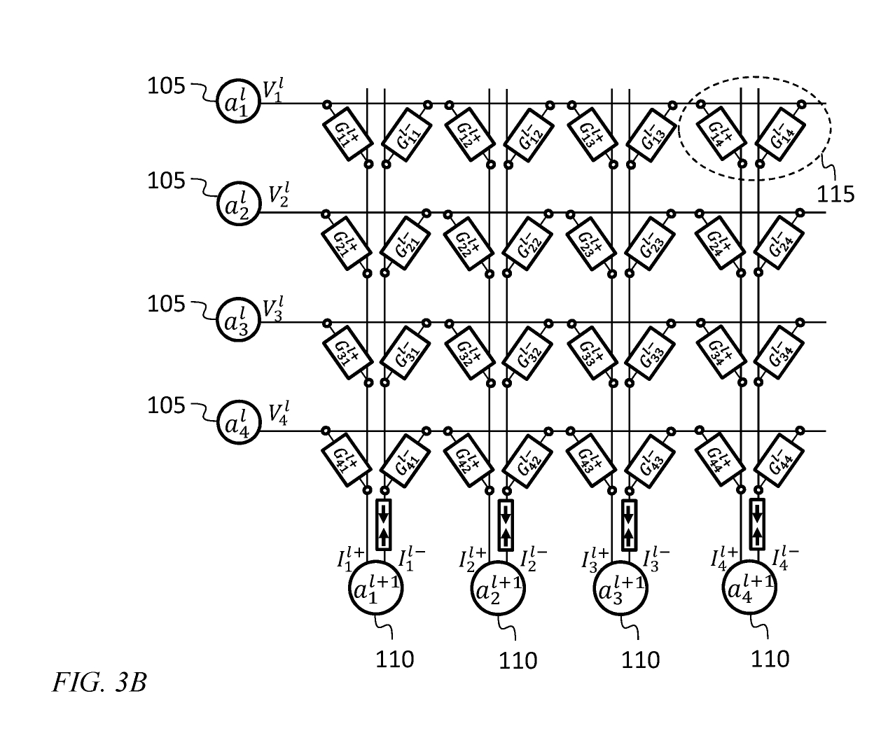

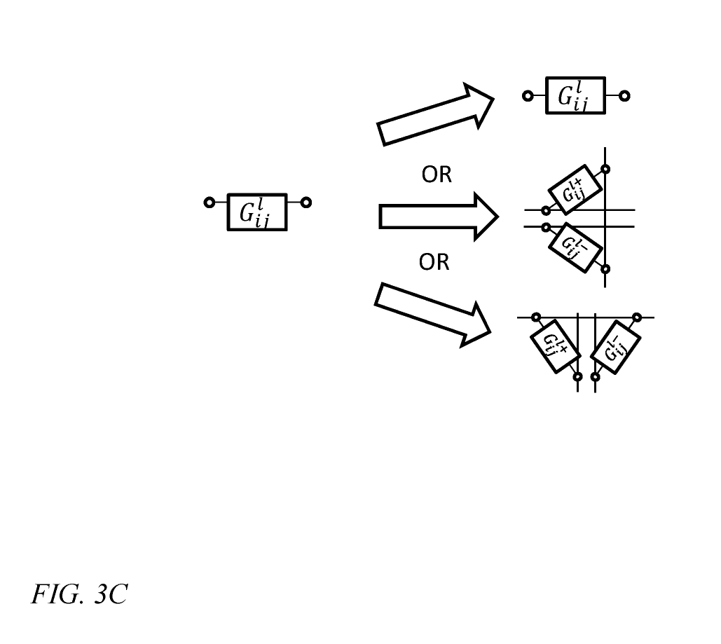

A modified circuit, such as that of FIG. 3A, may be used to implement negative weights using resistive elements having positive conductances. In such an embodiment, the output of each of the pre-synaptic artificial neurons 105 may be a pair of conductors carrying a differential voltage signal (i.e., a positive voltage on one of the conductors and a negative voltage, having the same absolute value, on the other conductor). In this embodiment, the weight of the artificial synapse 115 may be the difference between the conductances of the two resistive elements that form the artificial synapse 115. In another embodiment, illustrated in FIG. 3B, each of the pre-synaptic artificial neurons 105 has an output that is a voltage on a single conductor and each of the post-synaptic artificial neurons 110 has an input that is a pair of conductors, configured as a differential input. The differential input circuit of each of the post-synaptic artificial neurons 110 may be implemented, for example, with two of the transimpedance amplifiers of FIG. 2B, the outputs of the two transimpedance amplifiers being connected to a differential amplifier. FIG. 3C shows the three configurations by which a weight may be implemented using one or two resistive elements, the three configurations corresponding to the embodiments of FIG. 1, FIG. 3A, and FIG. 3B, respectively.

In some embodiments each weight is controllable or programmable to operate at any time in one of two states, e.g., a high-resistance state and a low-resistance state. Each such weight may be implemented or constructed, for example, as the programmable resistive element within a spin-transfer torque random access memory (STT-RAM) cell (e.g., an STT-RAM cell based on a magnetic tunneling junction (MTJ) device). Accordingly, in an embodiment such as that of FIG. 1, each artificial synapse may operate at any time in one of two states, and in an embodiment such as that of FIG. 3A or FIG. 3B, each artificial synapse may operate at any time in one of three states (four states are possible, but it may be advantageous to avoid the use of the state in which both programmable resistive elements are in the low-resistance state, as this state may result in the same input signal, at the post-synaptic artificial neuron 110, as the state in which both programmable resistive elements are in the high-resistance state, while consuming more current).

Artificial synapses 115 with relatively low precision, e.g., with two or three states, such as those illustrated in FIG. 3C, may provide acceptable performance for an artificial neural network (or simply “neural network”) in some circumstances (e.g., when used for some applications). In other circumstances (e.g., when used for other applications) significantly better performance may be possible if higher precision weights, each of which is programmable to operate in any of a larger number of states, are used.

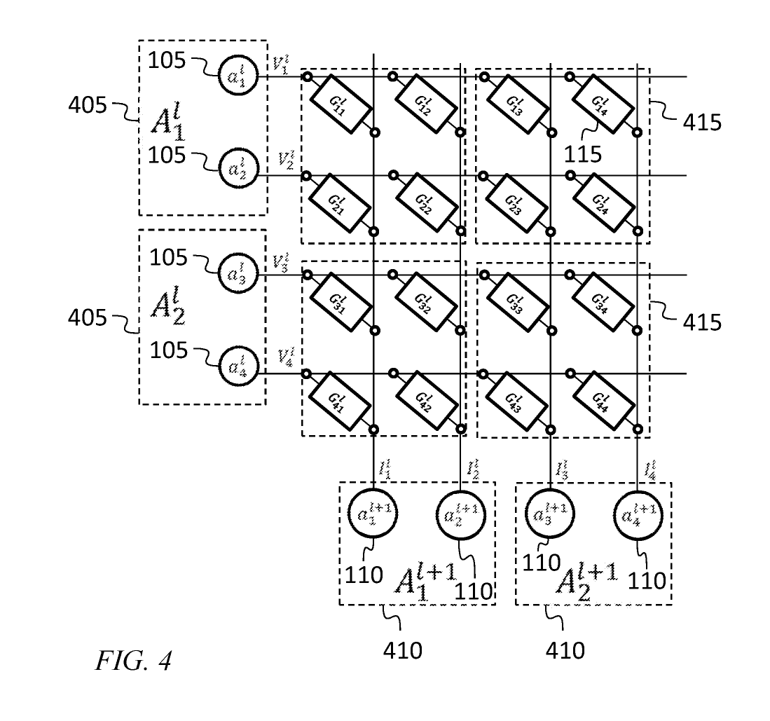

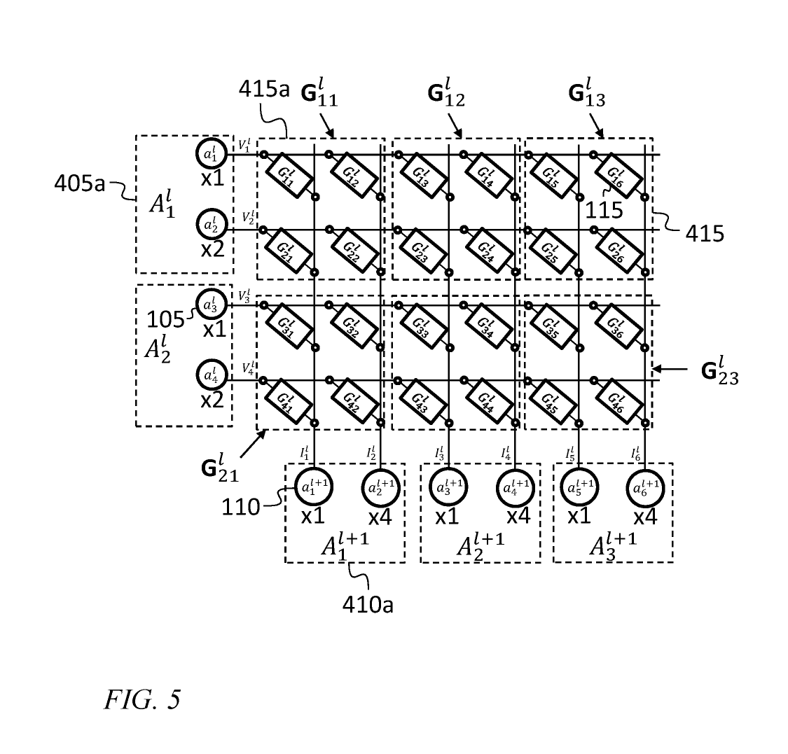

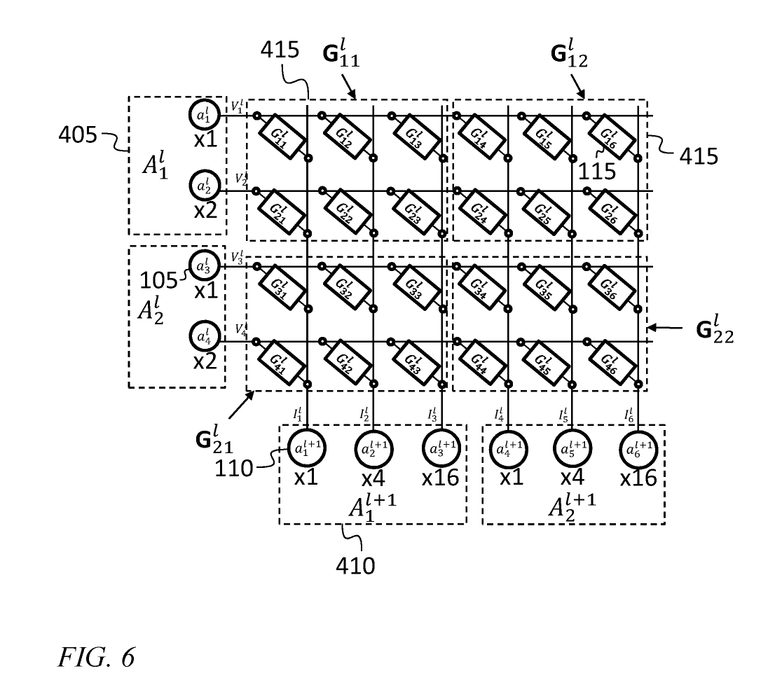

Referring to FIG. 4, in some embodiments, logical pre-synaptic neurons 405, logical post-synaptic neurons 410, and logical synapses 415 may be formed from sets of (physical) pre-synaptic artificial neurons 105, (physical) post-synaptic artificial neurons 110, and (physical) artificial synapses 115. In such an embodiment, the number of pre-synaptic artificial neurons 105, post-synaptic artificial neurons 110, and artificial synapses 115 may be adjusted to achieve any of a plurality of degrees of precision (e.g., 4 bits or 6 bits, in the related embodiments of FIGS. 5 and 6, respectively). For example, in the embodiment of FIG. 4, each of the logical pre-synaptic neurons 405 includes two pre-synaptic artificial neurons 105, each of the logical post-synaptic neurons 410 includes two post-synaptic artificial neurons 110, and each of the logical synapses 415 includes four artificial synapses 115. The logical pre-synaptic neurons 405, logical post-synaptic neurons 410, and logical synapses 415 may (like the pre-synaptic artificial neurons 105, the post-synaptic artificial neurons 110, and the artificial synapses 115) be artificial (i.e., not biological), but the qualifier “artificial” may be omitted herein for brevity. The inputs of the pre-synaptic artificial neurons 105 in each of the logical pre-synaptic neurons 405 may be connected together (forming the input of the logical pre-synaptic neuron 405), and the outputs of the post-synaptic artificial neurons 110 in each of the logical post-synaptic neurons 410 may be summed together (forming the output of the logical post-synaptic neuron 410).

Referring to FIG. 5, in one embodiment a layer including four pre-synaptic artificial neurons 105, twenty-four artificial synapses 115, and six post-synaptic artificial neurons 110 may be configured, by suitable programming, to operate as a layer with two logical pre-synaptic neurons 405, three logical post-synaptic neurons 410, and six logical synapses 415. Each of the pre-synaptic artificial neurons 105 includes a respective multiplier that is programmable to amplify, by a programmable gain factor, the output signal or input signal (in the case of pre-synaptic artificial neurons 105, or post-synaptic artificial neurons 110, respectively) of the artificial neuron. For example, in a first logical pre-synaptic neuron 405a, the first and second pre-synaptic artificial neurons 105 have multipliers programmed (as a result of programming operations used to configure the layer) to amplify the output signal of these pre-synaptic artificial neurons 105 by 1 and 2, respectively (as indicated by the labels “x1” and “x2” in FIG. 5). The first and second pre-synaptic artificial neurons 105 in the other one of the logical pre-synaptic neurons 405 are similarly programmed. Moreover, in the first logical post-synaptic neuron 410a, the first and second post-synaptic artificial neurons 110 have multipliers programmed to amplify the input signal of these post-synaptic artificial neurons 110 by 1 and 4, respectively (as indicated by the labels “x1” and “x4” in FIG. 5). The first logical synapse 415a, includes four artificial synapses 115 with weights that are further multiplied (by the multipliers in the logical pre-synaptic neurons 405 and in the post-synaptic artificial neurons 110) by gain factors of 1×1 (i.e., 1, for the weight G₁₁^{l}), 2×1 (i.e., 2, for the weight G₂₁^{l}), 1×4 (i.e., 4, for the weight G₁₂^{l}), and 2×4 (i.e., 8, for the weight G₂₂^{l}), respectively. The first logical synapse 415a therefore has a weight G₁₁^{l} that is programmable with a precision of 4 bits. Each multiplier may be implemented in (digital or analog) hardware as a multiplying circuit, or it may be implemented in software or firmware.

FIG. 6 shows the same sets of pre-synaptic artificial neurons 105, post-synaptic artificial neurons 110, and artificial synapses 115 as those shown in FIG. 5, configured instead to form a layer in which each of the logical synapses 415 has a weight Gᵢⱼ^{l} that is programmable with a precision of 6 bits. In general, for a layer in which each of the logical pre-synaptic neurons 405 includes N pre-synaptic artificial neurons 105 and each of the logical post-synaptic neurons 410 includes M post-synaptic artificial neurons 110, each multiplier in a pre-synaptic artificial neuron 105 may amplify the output signal by a gain factor selected from a set of N gain values being, respectively, A, 2A, 4A, . . . 2^{N-1}A, where A is a constant, and each multiplier in a post-synaptic artificial neuron 110 may amplify the input signal by a gain factor selected from a set of M gain values being, respectively B, 2^{N}B, 4^{2N}B, . . . 2^{(M-1)N}B, where B is a constant. The respective gain factor by which each of the pre-synaptic artificial neurons 105 of a logical pre-synaptic neuron 405 amplifies the output signal may be different from the gain factors by which each of the other pre-synaptic artificial neurons 105 of the logical pre-synaptic neuron 405 amplify their respective output signals. Similarly, the respective gain factor by which each of the post-synaptic artificial neurons 110 of a logical post-synaptic neuron 410 amplifies the input signal may be different from the gain factors by which each of the other post-synaptic artificial neurons 110 of the logical post-synaptic neuron 410 amplify their respective input signals.

In some embodiments, in a given layer all of the pre-synaptic artificial neurons 105 may be identical (except for the respective gain factors of their respective multipliers (i.e., they may differ only with respect to these gain factors)), all of the post-synaptic artificial neurons 110 may be identical (except for the respective gain factors of their respective multipliers (i.e., they may differ only with respect to these gain factors)), and all of the synapses may be identical (except for the respective programmed weights). As such, a neural network may be fabricated in which each layer has weights with a bit precision that may be selected, after fabrication, by suitable programming. Such a neural network may be said to have a neuromorphic architecture.

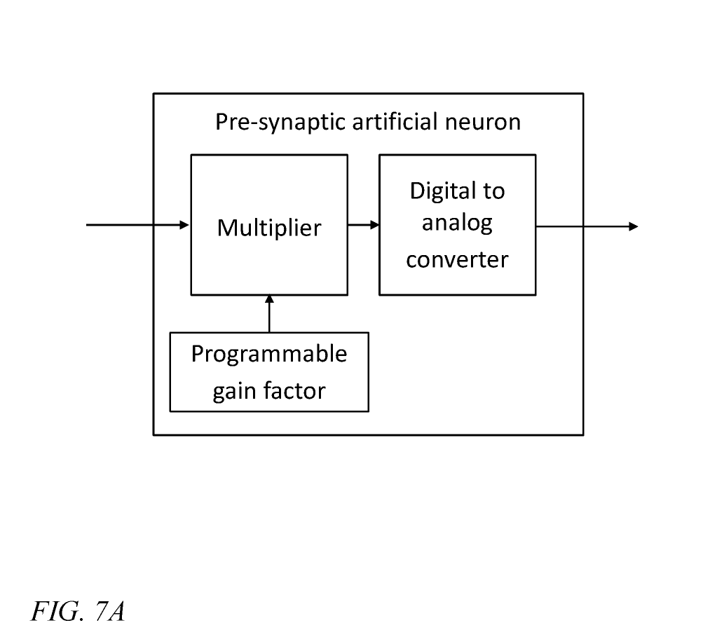

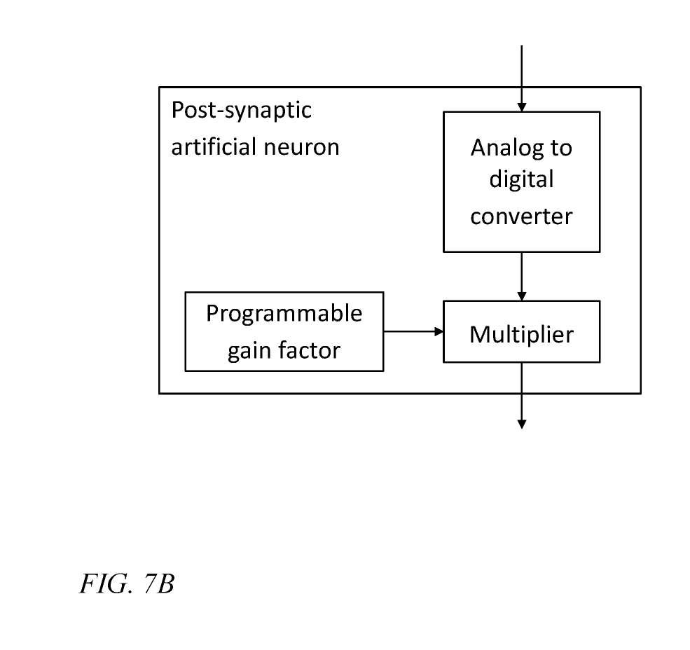

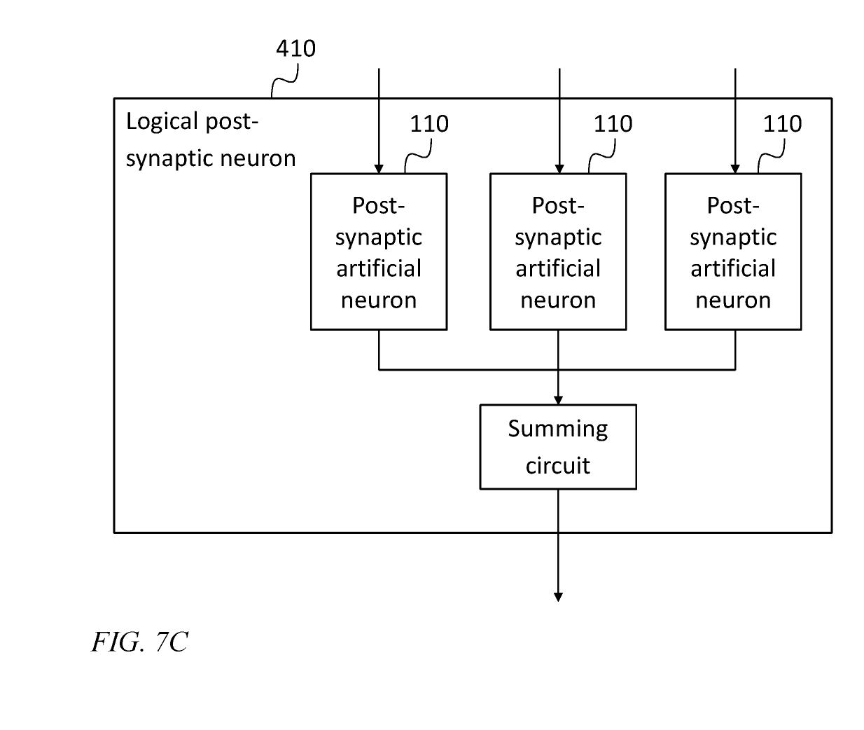

Referring to FIG. 7A, in some embodiments, the input of each pre-synaptic artificial neuron is a digital input, the multiplier of each pre-synaptic artificial neuron is a digital multiplier connected to the input of the pre-synaptic artificial neuron, and each pre-synaptic artificial neuron further comprises a digital to analog converter having an input connected to an output of the digital multiplier and an output connected to an output of the pre-synaptic artificial neuron. In such an embodiment the programmable gain factor may be implemented as a digital register feeding one of the inputs of the multiplier. The activation function of the pre-synaptic artificial neuron, if it includes one, may be connected in cascade before or after the multiplier (as a digital activation function) or after the digital to analog converter (as an analog activation function).

Referring to FIG. 7B, in some embodiments the output of each post-synaptic artificial neuron is a digital output, the multiplying circuit of each post-synaptic artificial neuron is a digital multiplying circuit connected to the output of the post-synaptic artificial neuron, and each post-synaptic artificial neuron further comprises an analog to digital converter having an input connected to an input of the post-synaptic artificial neuron and an output connected to an input of the digital multiplying circuit. In such an embodiment the programmable gain factor may be implemented as a digital register feeding one of the inputs of the multiplier. The activation function of the post-synaptic artificial neuron, if it includes one, may be connected in cascade before or after the multiplier (as a digital activation function) or before the analog to digital converter (as an analog activation function).

Referring to FIG. 7C, the summing of outputs of post-synaptic artificial neurons 110 in each of the logical post-synaptic neurons 410 may similarly be performed by a digital summing circuit. Multiple layers of a neural network may be cascaded together by connecting the outputs of the logical post-synaptic neurons 410 to the inputs of the logical pre-synaptic neurons 405 of a subsequent layer.

In light of the foregoing, some embodiments provide a neuromorphic architecture for providing variable precision in a neural network, through programming. Logical pre-synaptic neurons are formed as configurable sets of physical pre-synaptic artificial neurons, logical post-synaptic neurons are formed as configurable sets of physical post-synaptic artificial neurons, and the logical pre-synaptic neurons are connected to the logical post-synaptic neurons by logical synapses each including a set of physical artificial synapses. The precision of the weights of the logical synapses may be varied by varying the number of physical pre-synaptic artificial neurons in each of the logical pre-synaptic neurons, and/or by varying the number of physical post-synaptic artificial neurons in each of the logical post-synaptic neurons.

Each of the digital circuits mentioned herein may be, or may be a portion of, a processing circuit. The term “processing circuit” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example a processing circuit may include two processing circuits, an FPGA and a CPU, interconnected on a PCB.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed herein could be termed a second element, component, region, layer or section, without departing from the spirit and scope of the inventive concept.

The terminology used herein is for the purpose of describing particular embodiments only and is not intended to be limiting of the inventive concept. As used herein, the terms “substantially,” “about,” and similar terms are used as terms of approximation and not as terms of degree, and are intended to account for the inherent deviations in measured or calculated values that would be recognized by those of ordinary skill in the art.

As used herein, the singular forms “a” and “an” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the present invention”. Also, the term “exemplary” is intended to refer to an example or illustration. As used herein, the terms “use,” “using,” and “used” may be considered synonymous with the terms “utilize,” “utilizing,” and “utilized,” respectively.

It will be understood that when an element or layer is referred to as being “on”, “connected to”, “coupled to”, or “adjacent to” another element or layer, it may be directly on, connected to, coupled to, or adjacent to the other element or layer, or one or more intervening elements or layers may be present. In contrast, when an element or layer is referred to as being “directly on”, “directly connected to”, “directly coupled to”, or “immediately adjacent to” another element or layer, there are no intervening elements or layers present.

Although exemplary embodiments of a variable precision neuromorphic architecture have been specifically described and illustrated herein, many modifications and variations will be apparent to those skilled in the art. Accordingly, it is to be understood that a variable precision neuromorphic architecture constructed according to principles of this invention may be embodied other than as specifically described herein. The invention is also defined in the following claims, and equivalents thereof.

What is claimed is:

1. A neural network, comprising:
a plurality of pre-synaptic artificial neurons;
a plurality of post-synaptic artificial neurons; and
a plurality of artificial synapses,
each of the artificial synapses being connected between a respective pre-synaptic artificial neuron of the pre-synaptic artificial neurons and a respective post-synaptic artificial neuron of the post-synaptic artificial neurons, each of the artificial synapses having a respective weight,
each of the pre-synaptic artificial neurons comprising a respective multiplying circuit programmable to amplify its output signal by a gain factor selected from a set of N gain values being, respectively, A, 2A, 4A, . . . 2^{N-1}A, wherein N is an integer greater than 1 and A is a constant,
each of the pre-synaptic artificial neurons being programmed to amplify its output signal by a gain factor that is different from that of the other pre-synaptic artificial neurons,
each of the post-synaptic artificial neurons comprising a respective multiplying circuit programmable to amplify its input signal, and
each of the post-synaptic artificial neurons being programmed to amplify its output signal by a gain factor that is different from that of the other post-synaptic artificial neurons.

2. The neural network of claim 1, wherein each of the pre-synaptic artificial neurons is configured to produce, as an output signal, a voltage.

3. The neural network of claim 2, wherein each of the weights is a conductance of a resistive element.

4. The neural network of claim 3, wherein each resistive element is configured to operate in one of:
a first state, in which the resistive element has a first conductance; and
a second state, in which the resistive element has a second conductance different from the first conductance.

5. The neural network of claim 4, wherein each resistive element is a programmable resistive element within a spin-transfer torque random access memory cell.

6. The neural network of claim 4, wherein all of the weights have the same first conductance and all of the weights have the same second conductance.

7. The neural network of claim 3, wherein each of the post-synaptic artificial neurons is configured to receive, as an input signal, a current.

8. The neural network of claim 1, wherein each of the post-synaptic artificial neurons has a respective multiplying circuit programmable to amplify its output signal by a gain factor selected from a set of M gain values being, respectively, B, 2^{N} B, 4^{2N} B, . . . 2^{(M-1)N}B, wherein M is an integer greater than 1 and A is a constant.

9. A neural network comprising:
a plurality of logical pre-synaptic neurons;
a plurality of logical post-synaptic neurons; and
a plurality of logical synapses,
a first logical pre-synaptic neuron of the logical pre-synaptic neurons having an input and comprising N pre-synaptic artificial neurons, N being an integer greater than 1,
each of the N pre-synaptic artificial neurons having a respective input, all of the inputs of the pre-synaptic artificial neurons being connected to the input of the first logical pre-synaptic neuron,
a first logical post-synaptic neuron of the logical post-synaptic neurons having an output and comprising:
M post-synaptic artificial neurons, M being an integer greater than 1; and
a summing circuit having:
an output connected to the output of the first logical post-synaptic neuron, and
a plurality of inputs,
each of the M post-synaptic artificial neurons having a respective output, the output of each of the post-synaptic artificial neurons being connected to a respective input of the plurality of inputs of the summing circuit.

10. The neural network of claim 9, wherein each of the N pre-synaptic artificial neurons comprises a respective multiplying circuit programmable to amplify its output signal by a gain factor selected from a set of N gain values being, respectively, A, 2A, 4A, . . . 2^{N}A, wherein A is a constant.

11. The neural network of claim 10, wherein each of the M post-synaptic artificial neurons comprises a respective multiplying circuit programmable to amplify its output signal by a gain factor selected from a set of M gain values being, respectively, B, 2^{N}B, 4^{2N}B, . . . 2^{(M-1)N}B, wherein A is a constant.

12. The neural network of claim 11, wherein all of the pre-synaptic artificial neurons differ only with respect to their respective programmed gain factors.

13. The neural network of claim 12, wherein all of the post-synaptic artificial neurons differ only with respect to their respective programmed gain factors.

14. The neural network of claim 13, wherein:
an input of each pre-synaptic artificial neuron is a digital input;
the multiplying circuit of each pre-synaptic artificial neuron is a digital multiplying circuit connected to the input of the pre-synaptic artificial neuron; and
each pre-synaptic artificial neuron further comprises a digital to analog converter having an input connected to an output of the digital multiplying circuit and an output connected to an output of the pre-synaptic artificial neuron.

15. The neural network of claim 14, wherein:
an output of each post-synaptic artificial neuron is a digital output;
the multiplying circuit of each post-synaptic artificial neuron is a digital multiplying circuit connected to the output of the post-synaptic artificial neuron; and
each post-synaptic artificial neuron further comprises an analog to digital converter having an input connected to an input of the post-synaptic artificial neuron and an output connected to an input of the digital multiplying circuit.

16. The neural network of claim 15, wherein the first logical post-synaptic neuron further comprises a digital summing circuit having M inputs each connected to a respective one of the outputs of the M post-synaptic artificial neurons and an output connected to the output of the first logical post-synaptic neuron.

17. The neural network of claim 9, wherein:
each of the pre-synaptic artificial neurons is configured to produce, as an output signal, a voltage;
each of the logical synapses comprises a plurality of artificial synapses, each of the artificial synapses having a respective weight, each weights being a conductance of a resistive element; and
each of the post-synaptic artificial neurons is configured to receive, as an input signal, a current.

18. The neural network of claim 17, wherein each resistive element is configured to operate in one of:
a first state, in which the resistive element has a first conductance; and
a second state, in which the resistive element has a second conductance different from the first conductance.

19. The neural network of claim 18, wherein each resistive element is a programmable resistive element within spin-transfer torque random access memory cell.

20. A neural network, comprising:
a plurality of pre-synaptic artificial neurons;
a plurality of post-synaptic artificial neurons; and
means for forming a plurality of connections, each connection being between a respective pre-synaptic artificial neuron of the pre-synaptic artificial neurons and a respective post-synaptic artificial neuron of the post-synaptic artificial neurons,
each of the pre-synaptic artificial neurons comprising a respective multiplying circuit programmable to amplify its output signal by a gain factor selected from a set of N gain values being, respectively, A, 2A, 4A, . . . 2^{N-1}A, wherein N is an integer greater than 1 and A is a constant,
each of the pre-synaptic artificial neurons being programmed to amplify its output signal by a gain factor that is different from that of the other pre-synaptic artificial neurons,
each of the post-synaptic artificial neurons comprising a respective multiplying circuit programmable to amplify its input signal, and
each of the post-synaptic artificial neurons being programmed to amplify its output signal by a gain factor that is different from that of the other post-synaptic artificial neurons.
